(19) United States
(12) Patent Application Publication
(10) Pub. No.: US 2008/0289748 A1
(43) Pub. Date: Nov. 27, 2008

(54) METHOD OF APPLYING A DESIGN

(76) Inventor: J. Patrick Epling, Boynton Beach, FL (US)

Correspondence Address: The Intellect Law Group, 2400 SE Federal Highway, Suite 340, Stuart, FL, 34994, US

(21) Appl. No.: 11/753,276

(22) Filed: May 24, 2007

(51) Int. Cl. B44C 1/165; B44F 1/08

(52) U.S. Cl. 156/235; 428/29

(57) ABSTRACT

A method of applying a design to an article and product are disclosed. The method includes selecting a design, transferring the design to a transfer material, applying a base coat to the article, transferring the design from the transfer material to the article, and applying a top coat to the article having the design.

### TECHNICAL FIELD

This invention relates to a method of applying a decoration or design to an article or leather, vinyl, synthetic leather, or other similar material.

### BACKGROUND

Conventional methods of applying a design to leather exist. Typically, a pattern is designed and printed on paper with sublimation dyes for transfer to the leather surface, a coat is first applied to neutralize the surface and afford better adhesion. Then, the paper pattern is set into the heating plate used for surfacing the leather. The heating plate applies pressure and heat to transfer the dyes to the base coat.

Another known method is the water-transfer printing or hydrographic printing, which is based on a water-soluble film, usually polyvinyl alcohol (PVOH), upon which printed patterns of ink are applied. The PVOH is floated atop a clear water surface in an immersion tank. The film is sprayed with a chemical activator, thereby dissolving the film into a gelatin. The gelatin continues floating and remains intact. The product to be coated is immersed into the liquid and withdrawn allowing for transfer of the color and design elements of the original pattern. The product must be rinsed of any excess film residue and allowed to dry before a final clear coat is applied.

Conventional methods use dangerous and environmentally unfriendly chemicals with volatile organic compounds (VOCs). All of the ink from the pattern does not transfer to the product producing a faint design. Also, the design on the product is often distorted or uneven because of transfer process. There is difficulty in controlling the consistency, heat, and image intensity using conventional methods. Thus, there is a need in the art for a method of applying a design that can at least overcome the above-described problems.

### SUMMARY

Accordingly, the invention is directed to applying a design to leather or the like that substantially obviates one or more problems due to limitations and disadvantages of the related art.

The method allows for complete transfer of a design from a transfer material to leather, vinyl, synthetic, or the like, as well as two- and three-dimensional shaped articles.

A method is provided in which various designs and patterns can be realized, no matter the complexity.

The embodiments provide a safer, cheaper, more efficient method of applying a design. Chemical agents and VOCs are no longer necessary because the method described herein is not solution state. The consistency, heat, and image intensity are fully controllable factors with the method.

To achieve these advantages and in accordance with the purpose of the invention, as embodied and broadly described herein, there is provided a method of applying a design including the steps of: selecting a design, transferring the design to a transfer material, applying a base coat to the article, transferring the design from the transfer material to the article; and applying a top coat to the article having the design.

Other advantages will be apparent from the following description, the accompanying drawings and the appended claims.

### BRIEF DESCRIPTION OF THE DRAWINGS

FIG. 1 shows a flow diagram of an inventive process described herein;

FIG. 2 depicts another flow diagram of an inventive process described herein;

FIG. 3 shows a perspective view of a product with a design applied from a method as described herein.

### DETAILED DESCRIPTION

In the following detailed description, reference is made to various specific embodiments in which the invention may be practiced. These embodiments are described with sufficient detail to enable those skilled in the art to practice the invention, and it is to be understood that other embodiments may be employed, and that changes may be made without departing from the teachings of the invention.

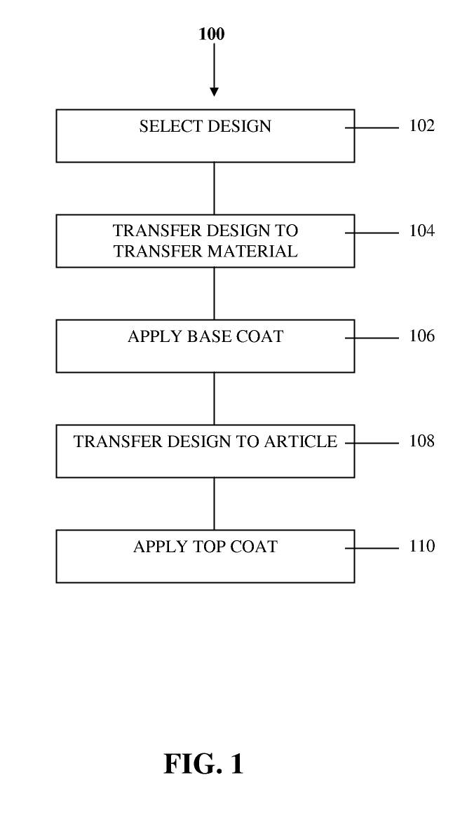

FIG. 1 shows a method of applying a design to an article (100). The article can be any two- or three-dimensional shaped article or made of leather, vinyl, synthetic leather, derivatives thereof, or other similar materials. A user or computer creates a design or selects a preexisting design (102). The selected a design is then transferred to a transfer material (104). The transfer material can be made of polyvinyl alcohol. Other suitable materials can also be used. Typically, the design is printed on the transfer material. Other known methods of transferring an image can also be used.

A base coat can be applied to the article (106). The base coat is usually made of polyurethane, acrylic, and/or other additives. Numerous base coat compositions are known in the art, such as Poseidon Compact BC-820 or AB-1017.

The design is then transferred from the transfer material to the article (108). In an embodiment, a heating plate is used. The heating plate temperature can range between 50° F. and 400° F. Preferably, the temperature range is between 150° F. and 250° F. The design is positioned over the desired location on the article. The heating plate contacts the design and presses the design onto the article. A 150 ton press can be used to press the design onto the article. Other known methods or size presses can likewise be used. Other transfer techniques such as dye sublimation or vapor deposition can be used.

After the design is transferred to the article, a top coat is applied to the article having the design affixed thereon (110). The top coat is applied according to the intended end use, preferably to provide durability and protection. The top coat can be made of similar material as the base coat, clear, glossy, or as desired. Top coats known in the art can be utilized according to the intended use of the article.

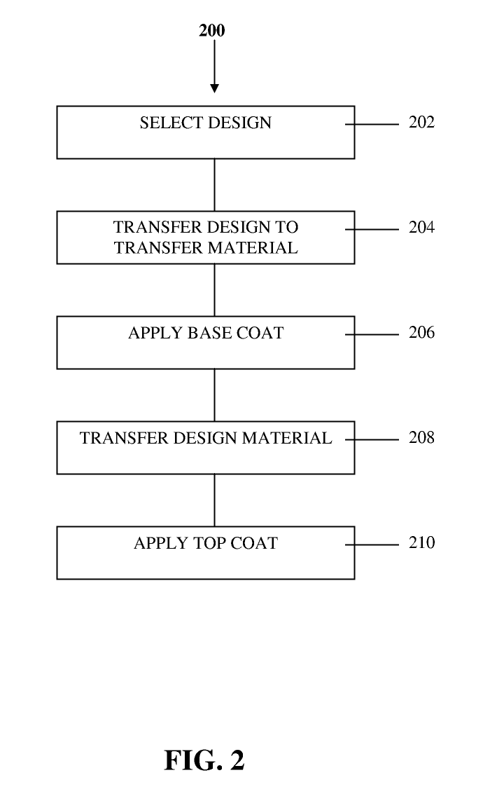

FIG. 2 describes another method of applying a design to leather, vinyl, synthetic leather, or combinations thereof (200). The method (200) entails selecting a design (202). The design can be created or selected from any preexisting designs. The design is transferred to a transfer material (204). The transfer material can be made of polyvinyl alcohol or any other suitable material. Typically, the design is printed on the transfer material, but other known methods of transferring an image can also be used.

A base coat can be applied to the article (206). The base coat is usually made of polyurethane, acrylic, and/or other additives. Numerous base coat compositions are known in the art, such as Poseidon Compact BC-820 or AB-1017.

The design is then transferred from the transfer material to the article (208). A heating plate can be used to transfer the design. The heating plate temperature can range between 50° F. and 400° F. Preferably, the temperature range is between 150° F. and 250° F. The design is positioned over the desired location on the article. The heating plate contacts the design for at least 2 seconds and presses the design onto the article. A 150 ton press can be used to press the design onto the article. Other known methods or size presses can likewise be used. Other transfer techniques such as dye sublimation or vapor deposition can likewise be used.

After the design is transferred to the article, a top coat is applied to the article having the design affixed thereon (210). The top coat is applied according to the intended end use, preferably to provide durability and protection. The top coat can be made of similar material as the base coat, clear, glossy, or as desired. Top coats known in the art can be utilized according to the intended use of the article.

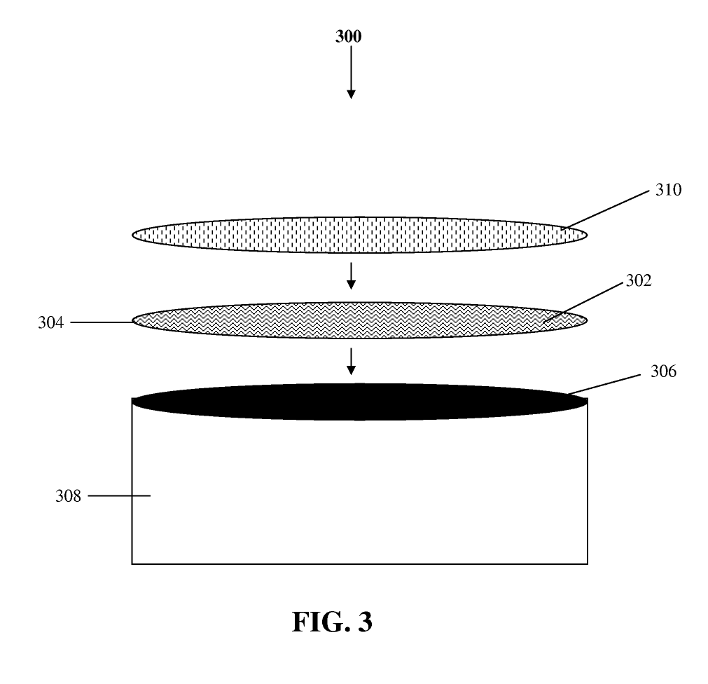

FIG. 3 describes a product (300) made by the process of: selecting a design (302); transferring the design to a transfer material (304); applying a base coat (306) to a material (308) that is made of leather, vinyl, synthetic leather, or combinations thereof; transferring the design from the transfer material to the material; and applying a top coat (310) to the material having the design. The material can be leather, vinyl, synthetic leather, or combinations thereof. The design can be created or selected from any preexisting designs. The transfer material can be made of polyvinyl alcohol or any other suitable material. Typically, the design is printed on the transfer material, but other known methods of transferring an image can also be used. The base coat is usually made of polyurethane, acrylic, and/or other additives, such as Poseidon Compact BC-820 or AB-1017, but other coatings can be utilized.

In an embodiment, the design is then transferred from the transfer material to the article using a heating plate. The heating plate temperature can range between 50° F. and 400° F., with the preferred temperature ranging between 150° F. and 250° F. The design is positioned over the desired location on the article. The heating plate contacts the design for at least 2 seconds and presses the design onto the article. A 150 ton press can be used to press the design onto the article. Other known methods or size presses can likewise be used. Other transfer techniques such as dye sublimation or vapor deposition can likewise be used. A top coat is applied to the article having the design affixed thereon. The top coat is applied according to the intended end use, preferably to provide durability and protection. The top coat can be made of similar material as the base coat, clear, glossy, or as desired. Top coats known in the art can be utilized according to the intended use of the article.

Additional advantages, features and modifications will readily occur to those skilled in the art. Therefore, the invention in its broader aspects is not limited to the specific details and embodiments, shown and described herein. Accordingly, various modifications may be made without departing from the spirit or scope of the general inventive concept as defined by the appended claims and their equivalents.

What is claimed is:

1. A method of applying a design to an article comprising:
selecting a design;
transferring said design to a transfer material;
applying a base coat to said article;
transferring said design from said transfer material to said article; and
applying a top coat to said article having said design.

2. The method of claim 1 wherein said article is selected from the group consisting of leather, vinyl, synthetic leather, derivatives thereof, and combinations thereof.

3. The method of claim 1 wherein said transfer material comprises polyvinyl alcohol.

4. The method of claim 1 wherein transferring said design from said transfer material to said article uses a heating plate.

5. The method of claim 4 wherein said heating plate is heated to at least 50° F.

6. The method of claim 5 wherein transferring said design from said transfer material to said article is by contacting said heating plate at 200° F. with said design for at least three seconds.

7. The method of claim 6 wherein said contacting occurs using a 150 ton press.

8. The product produced by the method of claim 1.

9. A method of applying a design to a material selected from the group consisting of leather, vinyl, synthetic leather, and combinations thereof, comprising: selecting a design, transferring said design to a transfer material, applying a base coat to said material, transferring said design from said transfer material to said material, and applying a top coat to said article with said design.

10. The method of claim 9 wherein said transfer material comprises polyvinyl alcohol.

11. The method of claim 9 wherein transferring said design from said transfer material to said material is by a heating plate heated to at least 100° F.

12. The method of claim 11 wherein said heating plate at 200° F. contacts with said design for at least three seconds.

13. The product produced by the method of claim 9.

14. A method of applying a design to a material selected from the group consisting of leather, vinyl, synthetic leather, and combinations thereof, comprising: selecting a design, transferring said design to a polyvinyl alcohol material, applying a base coat to said first material, transferring said design to said first material by contacting said polyvinyl alcohol material with a heating plate heated to at least 50° F. with said first material, and applying a top coat to said first material having said design thereon.

15. The method of claim 14 wherein said heating plate at 200° F. contacts with said design for at least three seconds.

16. The product produced by the method of claim 14.

17. The product resulting from the process comprising:
selecting a design;
transferring said design to a transfer material;
applying a base coat to a material selected from the group consisting of leather, vinyl, synthetic leather, and combinations thereof;
transferring said design from said transfer material to said material; and
applying a top coat to said material having said design.
